(19) United States
(12) Patent Application Publication
(10) Pub. No.: US 2013/0294916 A1
(43) Pub. Date: Nov. 7, 2013

(54) Inverted Tooth Silent Drive Chain for Wind Turbine Powertrain Applications

(71) Applicant: Richard A. Himmelmann, Beloit, WI (US)

(72) Inventor: Richard A. Himmelmann, Beloit, WI (US)

(73) Assignee: Clipper Windpower, LLC, Carpinteria, CA (US)

(21) Appl. No.: 13/462,209

(22) Filed: May 2, 2012

(51) Int. Cl. F03D 11/02; F03D 9/00; F16H 7/06

(52) U.S. Cl. 416/170 R; 474/148

(57) ABSTRACT

A powertrain for a wind turbine is provided. The powertrain may include a first stage speed increaser and a second stage speed increaser in communication with the first stage speed increaser. The first stage speed increaser may include a first stage drive wheel being driven by a main shaft of the wind turbine, and at least one first stage driven wheel being driven by the first stage drive wheel through one or more roller drive chains. The second stage speed increaser may include a second stage drive wheel being driven by the first stage driven wheel, and at least one second stage driven wheel being driven by the second stage drive wheel through one or more inverted tooth drive chains.

### FIELD OF THE DISCLOSURE

The present disclosure generally relates to wind turbines, and more particularly, relates to inverted tooth silent drive chains for wind turbine powertrains.

### BACKGROUND OF THE DISCLOSURE

Typical utility-scale wind turbines include a plurality of rotor blades which radially extend from a central rotor hub. The combined assembly of the rotor blades and the rotor hub is generally referred to as the rotor. The rotor blades aerodynamically interact with wind energy, creating lift and drag, which the rotor hub then translates into a driving torque. The driving torque is communicated from the rotor hub through a main shaft that is coupled to the rotor hub. The rotational torque is then distributed to one or more generators via a drivetrain or powertrain, which in turn produces electric power to be processed and transmitted to an associated electrical grid. The main shaft, the powertrain and the generators are all situated within a nacelle that is located on top of a tower.

It is a commonly shared interest to reduce the size and mass of components situated within the nacelle so as to minimize the costs associated with manufacturing, assembly, transportation, and the like. Among others, one of the larger components within the nacelle is the generator. Generators that are more directly driven by the main shaft of the wind turbine tend to be larger in size due to the lower operational speeds at which the blades and rotor hub drive the generator input. Thus, one way to enable significant reductions in generator size and mass is to increase the drive speed at the generator inputs to speeds that are compatible with smaller and lighter generators. This can be accomplished in one of a number of different ways, for example, using speed increasing powertrains consisting of gearboxes or drive chains configured to receive the lower rotational speed of the main shaft and supply a higher rotational drive speed to the generator inputs. While such configurations may prove to be adequate in certain respects, there is still much room for improvement.

Conventional gearboxes are commonly used to increase the speed of the main shaft of the wind turbine to a higher rotational speed that is compatible with conventional moderate to high speed electric power generators. However, the alignment of the gears in conventional gearboxes is critical for gear reliability. For instance, if any component in the gearbox, such as housings, gears, shafts, or the like, are deflected under a load during operation, the gears may become misaligned, resulting in substantial localized contact stresses. These stresses may further result in gear pitting and eventual gear failures. Gear misalignment problems become more prevalent in wind turbine applications, where the rotor hub assembly as well as the drive gear for the first stage speed increaser may be bolted or mounted to the input shaft of the gearbox assembly. As aerodynamic and gyroscopic loads are applied to the rotor hub assembly, the gearbox input shaft may be deformed by some finite amount, which tends to force the first stage drive gear out of alignment for the first stage driven gear.

As an alternative to less tolerant gearboxes, powertrains with roller drive chain configurations have also been considered and used to communicate rotor hub and main shaft rotations to generators. More specifically, these powertrains employ a drive sprocket that is rigidly coupled to the main shaft which rotatably engages a set of roller drive chains. The roller drive chains further engage a driven sprocket that is rigidly attached to a generator input such that rotations of the rotor hub and main shaft drive the generator and output electrical power. The geometry of roller drive chain configurations enables higher tolerance to misalignment, and thus, provides some benefits over the less tolerant conventional gearbox. However, roller drive chain configurations are only adequate for lower speed wind turbine operations and are not suited for moderate to high speed wind turbine operations. When used in higher speed, higher power applications, greater unidirectional accelerations are exerted on the rolling elements of the roller drive chains. This can lead to an asymmetric distribution of the rolling elements and lubrication fluids of the roller drive chain relative to the prescribed installation circumference, which can further result in binding as well as increased friction and wear on the rolling elements.

Accordingly, it would be beneficial to provide a powertrain which alleviates some of the disadvantages of conventional wind turbine powertrain applications. Specifically, there is a need for a powertrain which increases the rotational speed of the rotor hub and main shaft to speeds compatible with smaller and lighter generators. There is also a need for a powertrain that can support and safely handle low speed operations as well as high speed operations while reducing localized stresses on individual powertrain components. Moreover, there is a need for a speed increasing powertrain that is more tolerant to misalignments and thus more reliable.

### SUMMARY OF THE DISCLOSURE

In accordance with one aspect of the present disclosure, a speed increaser apparatus for a wind turbine is provided. The speed increaser apparatus may include at least one drive sprocket that is rotatably driven at least indirectly by a hub and a main shaft of the wind turbine, at least one driven sprocket that is rotatably driven by the drive sprocket, and at least one inverted tooth drive chain disposed at least partially about each of the drive and driven sprockets. The drive sprocket may be rotated at a first rotational speed in response to rotations of the main shaft. The driven sprocket may be rotated at a second rotational speed in response to rotations of the drive sprocket.

In accordance with another aspect of the present disclosure, a powertrain for a wind turbine is provided. The powertrain may include a first stage speed increaser and a second stage speed increaser in communication with the first stage speed increaser. The first stage speed increaser may include a first stage drive wheel being driven by a main shaft of the wind turbine, and at least one first stage driven wheel being driven by the first stage drive wheel through one or more roller drive chains. The second stage speed increaser may include a second stage drive wheel being driven by the first stage driven wheel, and at least one second stage driven wheel being driven by the second stage drive wheel through one or more inverted tooth drive chains.

In accordance with yet another aspect of the present disclosure, a wind turbine is provided. The wind turbine may include a hub, a main shaft rotating with the hub, a first stage speed increaser coupled to the main shaft, a second stage speed increaser coupled to the first stage speed increaser, and one or more generators being coupled to the second stage speed increaser. The first stage speed increaser may include a first stage drive wheel being driven by the main shaft, and at least one first stage driven wheel being driven by the first stage drive wheel through one or more roller drive chains. The second stage speed increaser may include a second stage drive wheel being driven by the first stage driven wheel, and at least one second stage driven wheel being driven by the second stage drive wheel through one or more inverted tooth drive chains.

Other advantages and features will be apparent from the following detailed description when read in conjunction with the attached drawings.

### BRIEF DESCRIPTION OF THE DRAWINGS

For a more complete understanding of the present disclosure, reference should be made to the embodiments illustrated in greater detail on the accompanying drawings, wherein:

FIG. 1 is a perspective view of a wind turbine constructed in accordance with at least some embodiments of the present disclosure;

FIG. 2 is a schematic view of an exemplary two-stage speed increaser powertrain as installed within a nacelle of a wind turbine and constructed in accordance with at least some of the embodiments of the present disclosure;

FIG. 3 is a perspective view of an exemplary roller drive chain configuration as implemented within a first stage of the powertrain of FIG. 2;

FIG. 4 is a perspective view of one exemplary set of roller drive chains and roller chain sprockets;

FIG. 5 is a cross-sectional view of a roller drive chain partially engaged about a roller chain sprocket;

FIG. 6 is a perspective view of an exemplary inverted tooth drive chain configuration as implemented within a second stage of the powertrain of FIG. 2;

FIG. 7 is a perspective view of one exemplary set of inverted tooth drive chains and inverted tooth sprockets; and

FIG. 8 is a cross-sectional view of an inverted tooth drive chain partially engaged about an inverted tooth sprocket.

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims eventually appended hereto.

### DETAILED DESCRIPTION OF THE DISCLOSURE

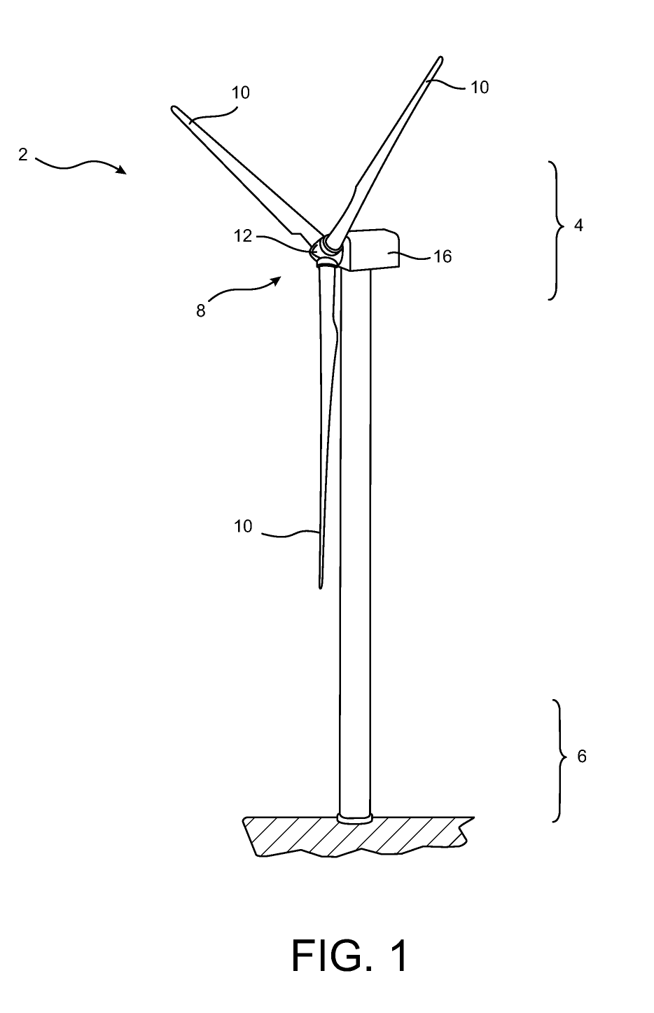

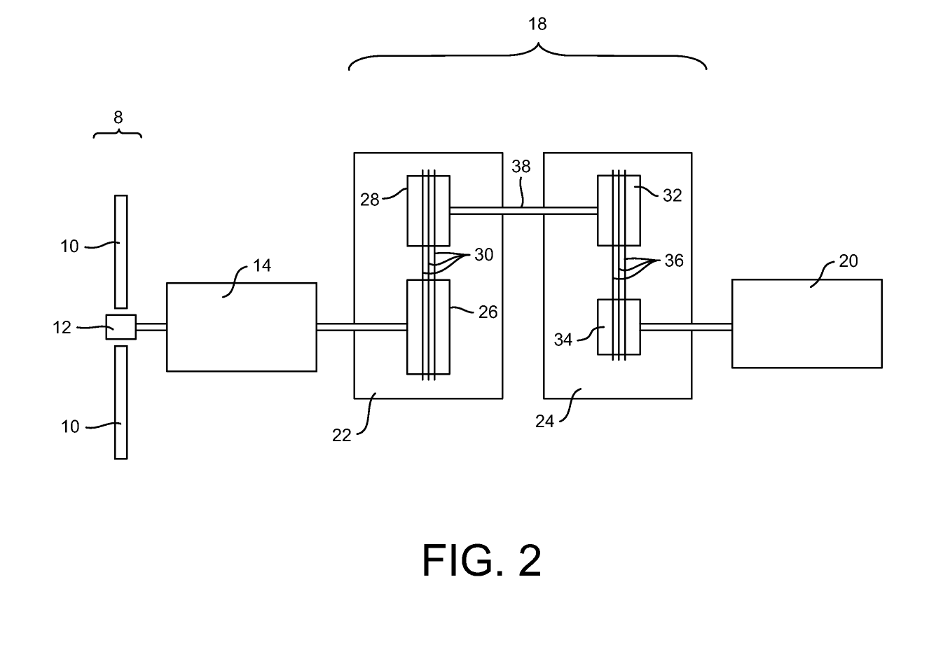

Referring to FIGS. 1 and 2, an exemplary wind turbine 2 is shown, in accordance with at least some embodiments of the present disclosure. While all the components of the wind turbine have not been shown and/or described, a typical wind turbine 2 may include an uptower section 4 and a downtower section 6. The uptower section 4 may include a rotor 8, which may further include a plurality of blades 10 radially extending from a central hub 12. The blades 10 may rotate with wind energy and the rotor 8 may transfer that energy to a main shaft 14 situated within a nacelle 16, as further illustrated in FIG. 2. The nacelle 16 may provide a powertrain 18 through which the main shaft 14 may rotatably drive one or more generators 20. In turn, the generators 20 may generate power, which may be transmitted from the uptower section 4 through the downtower section 6 to a power distribution panel (PDP), a pad mount transformer (PMT), and the like, for transmission to an associated electrical grid.

As shown more particularly in FIG. 2, the powertrain 18 may include multiple stages of speed increasers, such as a first stage speed increaser 22 and a second stage speed increaser 24. In general, the first stage 22 may be configured to increase a rotational speed of the main shaft 14 to a first rotational speed, while the second stage 24 may be configured to increase the first rotational speed to a second rotational speed at which one or more inputs of the generators 20 are driven. Moreover, each of the first and second stages 22, 24 may employ a drive chain configuration that is best suited for the speed range to which it is respectively designated. For instance, the first stage speed increaser 22 may be adapted to support relatively low speeds of wind turbine operation, such as any rotations of the hub 12 and the main shaft 14 that may be introduced by wind energy received at the blades 10. The second stage speed increaser 24 may be adapted to support relatively moderate to high speeds of wind turbine operation, and further, source relatively higher drive speeds that are compatible with smaller and lighter generators 20. Accordingly, the second rotational speed output by the second stage 24 may be greater than the first rotational speed output by the first stage 22. Furthermore, each of the first and second stages 22, 24 of the powertrain 18 may be adapted to provide more tolerance to misalignments and deflections which may be caused by aerodynamic and/or gyroscopic forces within the wind turbine 2.

Still referring to FIG. 2, the first stage speed increaser 22 may generally include a drive wheel 26 that is rigidly coupled to and rotating with the main shaft 14 of the wind turbine 2, as well as a driven wheel 28 that is rotatably coupled to the drive wheel 26 through one or more drive chains 30. Each of the drive and driven wheels 26, 28 may engage the drive chains 30 at least partially thereabout such that any rotation of the drive wheel 26 causes a corresponding rotation in the driven wheel 28. Furthermore, the driven wheel 28 may be sized to be smaller in circumference than the drive wheel 26 such that the driven wheel 28 rotates at a greater rotational speed than that of the drive wheel 26, hub 12 and the main shaft 14. The rotational output of the first stage 22 may then be communicated to the second stage speed increaser 24, which is adapted for relatively moderate to high speeds of wind turbine operation.

Similar to the first stage speed increaser 22, the second stage speed increaser 24 may also include a drive wheel 32 and a driven wheel 34. Specifically, the second stage drive wheel 32 may be rigidly coupled to and rotating with the first stage driven wheel 28, while the second stage driven wheel 34 may be rotatably coupled to the second stage drive wheel 32 through another set of drive chains 36. As shown, the first stage driven wheel 28 and the second stage drive wheel 32 may be coaxially coupled along a single shared drive shaft 38. However, in alternative embodiments, the first stage driven wheel 28 and the second stage drive wheel 32 may be coaxially disposed on and incorporated into a single drive wheel having a surface area configured to receive both drive chains 30, 36. The drive chains 32 of the second stage 24 may be at least partially engaged about each of the second stage drive and driven wheels 32, 34 such that any rotation of the first stage driven wheel 28 and the second stage drive wheel 32 causes a corresponding rotation in the second stage driven wheel 34. Additionally, the driven wheel 34 may be sized to have a circumference that is less than that of the drive wheel 32 such that the driven wheel 34 rotates at a speed that is greater than that of the corresponding drive wheel 32, but is also compatible for driving the inputs of lightweight generators 20. Correspondingly, each of the driven wheels 34 of the second stage 24 may be directly coupled to an input of one of the generators 20.

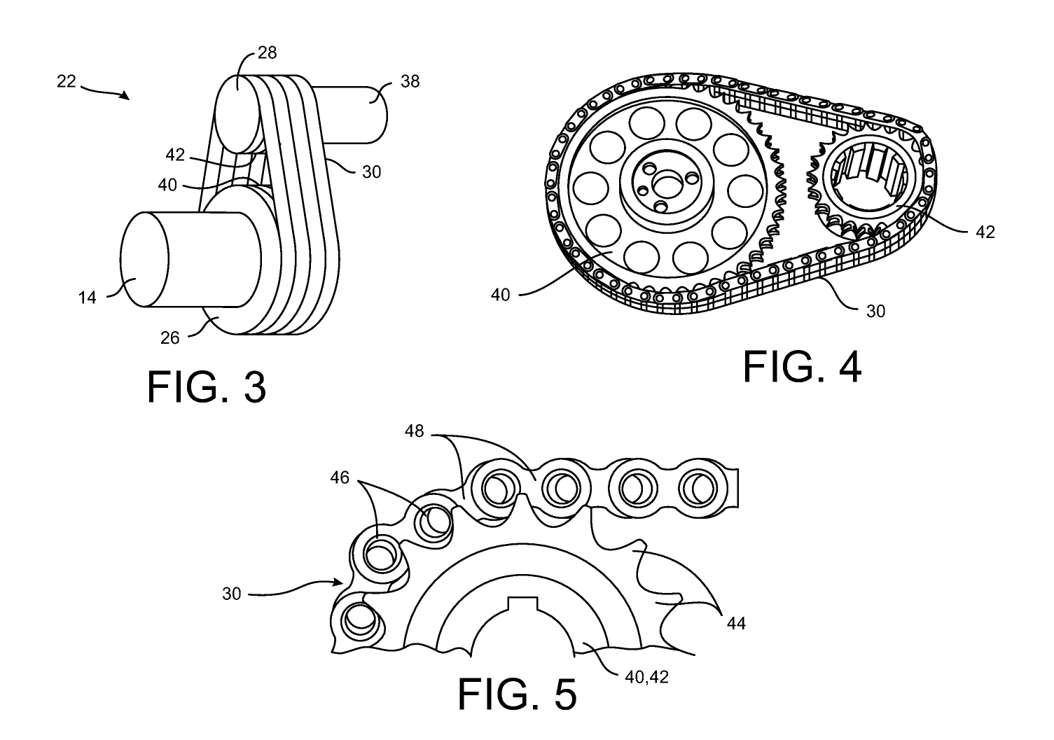

Turning to FIG. 3, the first stage speed increaser 22 of the powertrain 18 may employ a drive chain configuration in which one or more drive chains 30 are engageably disposed at least partially about the outer surface of each of the drive and driven wheels 26, 28. More specifically, the first stage 22 may employ roller drive chains 30, as shown in FIG. 4, to communicate relatively low speed rotations of the main shaft 14, for example, caused by wind energy received at the blades 10, between the drive and driven wheels 26, 28. Correspondingly, roller chain sprockets, such as the drive sprocket 40 and the driven sprocket 42 of FIG. 4, for example, may be disposed on or about the drive wheel 26 and driven wheel 28, respectively, and configured to engage the roller drive chains 30. As with conventional roller drive chain configurations, and as shown in FIG. 5, for example, a set of teeth 44 radially extending from the drive sprocket 40 may engage rollers 46 located between each roller chain link 48 to cause the roller drive chain 30 to rotate thereabout. Similarly, as the roller drive chain 30 travels about the drive sprocket 40, the rollers 46 may engage the teeth 44 of the driven sprocket 42, and thus, cause the driven wheel 28, as well as any attached drive shaft 38, or the like, to rotate therewith.

Although other drive chains may be employed, the first stage speed increaser 22 may employ roller drive chains 30 and roller chain sprockets 40, 42 for their ability to maintain traction and alignment with relatively more consistency at such low rotational speeds. Furthermore, the use of roller drive chains 30 and roller chain sprockets 40, 42 may provide more tolerance to any deflection within the main shaft 14 resulting from aerodynamic and/or gyroscopic forces received at the blades 10 of the wind turbine 2. Additionally, while the embodiments of FIGS. 3 and 4 are shown with a plurality of roller drive chains 30 and a plurality of corresponding roller chain sprockets 40, 42, it will be understood that other modifications may result in the use of a single roller drive chain and a corresponding set of roller chain sprockets that are appropriately sized or scaled to sufficiently support loads associated therewith.

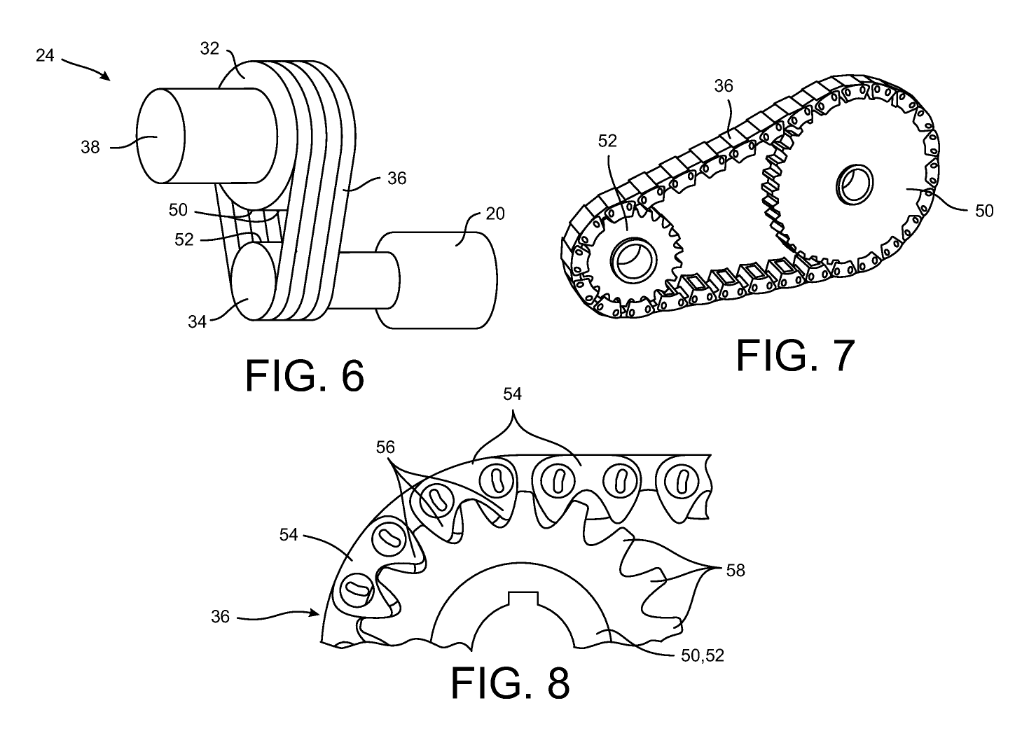

With reference now to FIG. 6, the second stage speed increaser 24 of the powertrain 18 may similarly employ a drive chain configuration in which one or more drive chains 36 are engageably disposed at least partially about the outer surface of each of the drive and driven wheels 32, 34. In contrast to the roller drive chain configuration of the first stage 22, however, the second stage 24 may employ one or more inverted tooth silent drive chains 36, as shown in FIG. 7, to communicate relatively moderate to high speed rotations between the drive and driven wheels 32, 34. Correspondingly, inverted tooth chain sprockets, such as the drive sprocket 50 and the driven sprocket 52 of FIG. 7, for example, may be disposed on or about the drive wheel 32 and driven wheel 34, respectively, and configured to engage the inverted tooth drive chains 36. As shown in FIG. 8, and in contrast to roller drive chain configurations, the inverted tooth drive chain 36 may provide an overlapping mesh of links 54 and inverted teeth 56 inwardly extending therefrom. The inverted teeth 56 and the spacing between the sprocket teeth 58 may be sized such that the inverted teeth 56 grip the sprocket teeth 58 therebetween as the inverted tooth drive chain 36 travels about the drive and driven sprockets 50, 52. In such a way, a rotation of the driven wheel 28 within the first stage 22 may rotate the drive sprocket 50 and the inverted tooth drive chains 36 of the second stage 24 to cause a corresponding rotation in the driven sprocket 52. Moreover, the driven sprocket 52 may be substantially smaller than the drive sprocket 50 so as to supply an increased drive speed that is compatible with smaller and lighter generators 20 coupled thereto.

While other drive chain configurations may be employed, the second stage speed increaser 24 may employ inverted tooth silent drive chains 36 and inverted tooth drive chain sprockets 50, 52 for their ability to more consistently maintain traction at moderate to high rotational speeds of operation. Furthermore, inverted tooth drive chains 36 may provide a drive configuration that is relatively more tolerant to misalignments as compared with conventional gearboxes configured for comparable speeds, as well as a more silent alternative to roller drive chain configurations. Additionally, while the embodiments of FIGS. 6 and 7 are shown with a plurality of inverted tooth drive chains 36 and a plurality of corresponding inverted tooth chain sprockets 50, 52, it will be understood that other modifications may result in use of a single inverted tooth drive chain and a corresponding set of inverted tooth chain sprockets that are appropriately sized or scaled to sufficiently support loads associated therewith.

Thus, the present disclosure sets forth an efficient as well as a reliable powertrain for wind turbine applications which enables the use of substantially smaller and lighter generators within the wind turbine nacelle. Moreover, the present disclosure provides a multi-stage speed increasing powertrain which effectively increases the rotational speed of the main shaft to drive speeds compatible with smaller lightweight generators. A first stage speed increaser of the powertrain comprises a roller drive chain configuration that is well adapted to receive the lower rotational speeds associated with the hub and the main shaft, while a second stage speed increaser of the powertrain comprises an inverted tooth silent drive chain configuration that is well adapted for more moderate to higher rotational speeds required by the smaller and lighter generators. By using at least two distinct drive chain configurations, each adapted for a different range of speed, the powertrain operates more effectively and more efficiently within a wider range of operating speeds. Furthermore, because the powertrain employs drive chains rather than conventional gearboxes to increase the speed, the powertrain is less prone to misalignments which may be caused by aerodynamic and/or gyroscopic forces exerted on the wind turbine. Still further, use of the inverted tooth silent drive chains enable high speed powertrain operations with significantly less noise being emitted from the nacelle of each wind turbine.

While only certain embodiments have been set forth, alternatives and modifications will be apparent from the above description to those skilled in the art. These and other alternatives are considered equivalents and within the spirit and scope of this disclosure and the appended claims.

We claim:

1. A speed increaser apparatus for a wind turbine, comprising:
at least one drive sprocket that is rotatably driven at least indirectly by a hub and a main shaft of the wind turbine, the drive sprocket being rotated at a first rotational speed in response to rotations of the main shaft;
at least one driven sprocket that is rotatably driven by the drive sprocket, the driven sprocket being rotated at a second rotational speed in response to rotations of the drive sprocket; and
at least one inverted tooth drive chain disposed at least partially about each of the drive and driven sprockets.

2. The apparatus of claim 1, wherein the driven sprockets are coupled to an input of at least one generator associated with the wind turbine and configured to rotatably drive the generator in response to rotations of the main shaft, the generator input being rotated at a higher rotational speed than the main shaft.

3. The apparatus of claim 1, wherein the second rotational speed is greater than the first rotational speed, the first rotational speed being configured for relatively low speed wind turbine operations, the second rotational speed being configured for relatively moderate to high speed wind turbine operations.

4. The apparatus of claim 1, wherein the drive sprocket is rotatably driven indirectly by the main shaft through a first stage speed increaser disposed in communication between the main shaft and the drive sprocket.

5. The apparatus of claim 4, wherein the first stage speed increaser is configured for relatively low speed wind turbine operations, the first stage speed increaser including a low speed drive sprocket that is coupled to the main shaft and a low speed driven sprocket that is rotatably driven by the low speed drive sprocket through one or more roller drive chains disposed at least partially thereabout

6. The apparatus of claim 1, wherein the drive sprocket is driven directly by the main shaft in a wind turbine configured for only high speed operations.

7. A powertrain for a wind turbine, comprising:
a first stage speed increaser including a first stage drive wheel being driven by a main shaft of the wind turbine and at least one first stage driven wheel being driven by the first stage drive wheel through one or more roller drive chains; and
a second stage speed increaser in communication with the first stage speed increaser, the second stage speed increaser including a second stage drive wheel being driven by the first stage driven wheel and at least one second stage driven wheel being driven by the second stage drive wheel through one or more inverted tooth drive chains.

8. The powertrain of claim 7, wherein each of the first stage drive and driven wheels includes sprockets configured to receive roller drive chains, and each of the second stage drive and driven wheels includes sprockets configured to receive inverted tooth drive chains.

9. The powertrain of claim 7, wherein the first stage driven wheel rotates at a first rotational speed and the second stage driven wheel rotates at a second rotational speed, the second rotational speed being greater than each of the first rotational speed and a rotational speed of the main shaft.

10. The powertrain of claim 7, wherein the first stage speed increaser is configured for relatively low speed operations and the second stage speed increaser is configured for relatively moderate to high speed operations.

11. The powertrain of claim 7, wherein the second stage driven wheels are coupled to an input of at least one generator associated with the wind turbine and configured to drive the generator in response to rotations of the main shaft.

12. The powertrain of claim 7, wherein the first stage driven wheel and the second stage drive wheel are coaxially coupled along a single shared drive shaft, the shared drive shaft providing roller chain sprockets for receiving the roller chain associated with the first stage speed increaser and inverted tooth chain sprockets for receiving the inverted tooth chain associated with the second stage speed increaser.

13. The powertrain of claim 7, wherein the first stage driven wheel and the second stage drive wheel are coaxially disposed on a single shared drive wheel, the shared drive wheel having roller chain sprockets for receiving the roller chain associated with the first stage speed increaser and inverted tooth chain sprockets for receiving the inverted tooth chain associated with the second stage speed increaser.

14. A wind turbine, comprising:
a hub;
a main shaft rotating with the hub;
a first stage speed increaser coupled to the main shaft, the first stage speed increaser including a first stage drive wheel being driven by the main shaft and at least one first stage driven wheel being driven by the first stage drive wheel through one or more roller drive chains;
a second stage speed increaser coupled to the first stage speed increaser, the second stage speed increaser including a second stage drive wheel being driven by the first stage driven wheel and at least one second stage driven wheel being driven by the second stage drive wheel through one or more inverted tooth drive chains; and
one or more generators being coupled to the second stage speed increaser.

15. The wind turbine of claim 14, wherein each of the first stage drive and driven wheels include sprockets configured to receive the roller drive chains, and each of the second stage drive and driven wheels include sprockets configured to receive the inverted tooth drive chains.

16. The wind turbine of claim 14, wherein the first stage speed increaser is adapted for relatively low speed operations, and the second stage speed increaser is adapted for relatively moderate to high speed operations.

17. The wind turbine of claim 14, wherein the first stage driven wheel and the second stage drive wheel are coaxially coupled along a single shared drive shaft, the shared drive shaft providing roller chain sprockets for receiving the roller chain associated with the first stage speed increaser and inverted tooth chain sprockets for receiving the inverted tooth chain associated with the second stage speed increaser.

18. The wind turbine of claim 14, wherein the first stage driven wheel and the second stage drive wheel are coaxially disposed on a single shared drive wheel, the shared drive wheel having roller chain sprockets for receiving the roller chain associated with the first stage speed increaser and inverted tooth chain sprockets for receiving the inverted tooth chain associated with the second stage speed increaser.

19. The wind turbine of claim 14, wherein each generator includes an input that is coupled to at least one of the second stage driven wheels.

20. The wind turbine of claim 14, wherein the generators are configured to generate electrical power in response to rotations of the hub and the main shaft, a rotational speed of the generator input being substantially greater than a corresponding rotational speed of the hub and the main shaft.
